(19) United States
(12) Patent Application Publication
(10) Pub. No.: US 2007/0075563 A1
(43) Pub. Date: Apr. 5, 2007

(54) Vehicle port

(76) Inventor: David M. Patrice, Randolph, MA (US)

Correspondence Address: ADVANTIA LAW GROUP, 9035 SOUTH 1300 EAST, SUITE 200, SANDY, UT, 84094, US

(21) Appl. No.: 11/243,303

(22) Filed: Oct. 3, 2005

(51) Int. Cl. B60J 7/20

(52) U.S. Cl. 296/136.01

(57) ABSTRACT

A vehicle port including a base of substantially inflexible material; a cap of substantially inflexible material, hingedly attached at one end to the base; a lift-assistance device attached at one end of the vehicle port to both the cap and the base; and a securing device attached to both the cap and the base, wherein the cap and the base each comprise perimeter edges which couple. The lift-assistance device may be a hydraulically powered device to substantially lift the cap from the base providing an opening through which a vehicle may be may be moved. The vehicle port may include a window. The cap and base may be fiberglass. The coupling of the perimeter edges of the cap and the base may be substantially impervious to water. The coupling of the perimeter edges of the cap and base may allow the passage of moisture.

### BACKGROUND OF THE INVENTION

1. Field of the Invention

The present invention relates to vehicle ports, specifically sturdy ports for the protection of vehicles.

2. Description of the Related Art

In U.S. Pat. No. 6,405,862, a motor vehicle flood protection apparatus includes a plastic container member having a bottom panel and integrally joined end, and side panels that have edges joined to form a vehicle container. The end and side panels have a vertical height that is less than the height of a vehicle to be flood protected but well above the float level for the motor vehicle and of sufficient height that, when surrounded by floodwaters, the container floats with the vehicle carried therein. A pair of reinforcement strips joined to the bottom panel resists puncture of the plastic container member. One or more flap members are joined to the side of the container and a plurality of grommets are provided in the one or more flap members. A tether line for securing the plastic container member (with a vehicle thereon) to a stationary object that can be coupled to the grommets on the flaps.

Disclosed in U.S. Patent Application Publication No. 2003/0071480 a car shade and flood protection arrangement includes a car shade for covering the whole body of a car, a sensor adapted to detect water level upon a flood, a water bag to be mounted in the car covered by the car shade, and a water pump adapted to pump water from the flood into the water bag to increase the weight of the car and to prevent the car from floating in the flood when the water level of the flood surpassed a predetermined level.

Also disclosed is U.S. Pat. No. 6,059,105, which discloses a motor vehicle flood protection apparatus and method includes a lower plastic container or cover member having a rectangular bottom panel and integrally joined end, and side panels that have lateral edges joined to form a leak proof vehicle container or bag. The end and side panels have a vertical height that is less than the height of a vehicle to be flood protected but well above the float level for the vehicle type and of sufficient height that, when surrounded by floodwaters, the container floats with the vehicle carried therein. The upper edges of the side and end panels have elastic and/or drawstring snugging devices to snug the upper edges against the vehicle. A top cover member is fitted over the upper edges of the bottom cover in a way so as to shed rainwater and/or splashing floor waters. A tether or anchor device secures the lower plastic container member to a stationary object.

U.S. Pat. No. 4,315,535 discloses a flood protection apparatus for vehicles which comprises the unitary flexible container, having at least a bottom, and a continuous side wall integrally and sealable connected thereto and extended upward during operation, an upper orifice in the container for receiving a vehicle within, a length of cord housed within a continuous channel on the uppermost end of the side wall for constricting the orifice of the container after the vehicle has been placed within, at least one marking place on the bottom of the container running its length, and up at least one side of the container for indicating placement of the tires of the vehicle within the container. The walls of the container are collapsible, and the container material would be a multi-layer flexible material, with the outer most and inner most layers being plastic based, and the middle layer being a canvas type material.

Further, U.S. Pat. No. 6,068,120 discloses a durable, versatile and economical device for securing and protecting bicycles, motorcycles, personal watercraft, snowmobiles, all-terrain vehicles and the like. The device comprises a shell or lid attached to a base. Alternatively, the shell can be secured to the floor, ground or wall without a base structure. The shell can be lifted around a pivot point to access the vehicle and lowered to secure it. When closed in the down position, the shell can be locked to the frame, completely securing and encapsulating the vehicle. The preferred plastic shell is an economical and durable cover, particularly when crime and vandalism is an issue.

What is needed is a vehicle port that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available vehicle ports. Accordingly, the present invention has been developed to provide a vehicle port A vehicle port, including a base of substantially inflexible material; a cap of substantially inflexible material, hingedly attached at one end to the base; a lift-assistance device attached at one end of the vehicle port to both the cap and the base; and a securing device attached to both the cap and the base, wherein the cap and the base each comprise perimeter edges which couple.

The lift-assistance device may include a hydraulically powered device pressurized to lift the cap from the base providing an opening through which a vehicle may be moved. The vehicle port may include a window. The cap and the base be fiberglass. The coupling of the perimeter edges of the cap and the base may be substantially impervious to water.

According to another embodiment, the vehicle port of this invention includes only: a base of substantially inflexible material; a cap of substantially inflexible material, hingedly attached at one end to the base; a window; a lift-assistance device attached at one end of the vehicle port to both the cap and the base; and a securing device attached to both the cap and the base, wherein the cap and the base each comprise perimeter edges which couple.

The lift-assistance device may be a hydraulically powered device pressurized to lift the cap from the base providing an opening through which a vehicle may be moved. The cap and the base are fiberglass. The coupling of the perimeter edges of the cap and the base are substantially impervious to water.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a side plan view of the vehicle port with a vehicle inside according to one embodiment of the present invention;

FIG. 2 illustrates a side plan view of the vehicle port with a vehicle inside according to one embodiment of the present invention; and

FIG. 3 illustrates a perspective view of the vehicle port according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

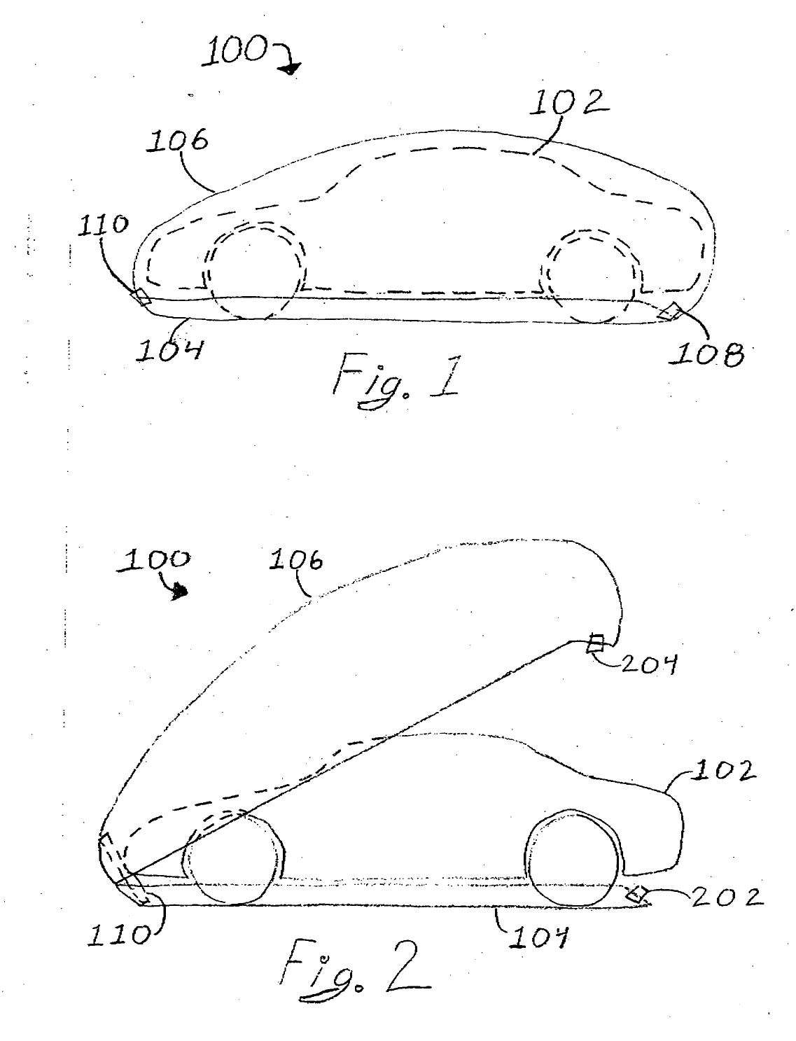

FIG. 1 illustrates a vehicle port 100 according to one embodiment of the present invention. According to this embodiment, the vehicle port 100 includes a cap 106 and a base 104. The cap 106 may be designed to protect the contents of the vehicle port 100 from elements that may be dropped from above such as, for example, construction debris, branches, leaves, plant debris, bird droppings, squirrel droppings, animal debris, rain, hail, snow, sleet, and so forth. The cap 106 and base 104 may be hingedly attached at one end of the vehicle port 100. The hinged attachment may include any known in the art. The cap 106 and the base 104 may be attached such that the cap 106 may be lifted from the base at one end of the base 104 such that a vehicle 102 may be moved to the interior of the vehicle port 100. Once the vehicle 102 is moved to the interior of the vehicle port 100, the cap 106 may be closed onto the base 104 such that the vehicle 102 remains substantially covered from the top and the bottom by the vehicle port 100.

The vehicle 102 to be moved into the vehicle port 100 may be any that is desired to be protected by the vehicle port 100. Some non-limiting examples of the vehicle 102 may include cars, trucks, motorcycles, bicycles, motor scooters, mopeds, and so forth.

The cap 106 and the base 104 may include perimeter edges that couple. The coupling may be along the entire perimeter edges of the cap 106 and base 104. The coupling may be such that elements that may harm the vehicle are kept without the vehicle port 100. In one embodiment, the coupling is substantially impervious to elements that may be blown by the wind such as dirt, dust, leaves, debris, and so forth. In this embodiment, the vehicle port 100 keeps out elements so that the vehicle 102 may remain in a substantially undamaged state though it is not be parked in a garage. In another embodiment, the coupling is substantially impervious to water. In yet another embodiment, the coupling is substantially impervious to elements that may be blown by the wind, but allows moisture to pass through. It may be advantageous to allow water to pass through the vehicle port 100 for various reasons. One such reason is that the air inside the vehicle port 100 may become saturated with water that may be created by combustion, or generated by any other process of the vehicle. If this moisture is allowed to remain inside the vehicle port 100, then the vehicle may be subjected to more oxidation than if the vehicle were left in a garage.

The vehicle port 100 also may include a securing device 108. The securing device 108 may be attached to the cap 106, the base 104 or both the cap 106 and base 104. The securing device 108 may be designed to secure the vehicle port 100 in a closed position. In one embodiment, the securing device 108 may allow for a lock to be placed such that the cap cannot be opened from the base without first removing the lock. In such an embodiment, the vehicle port 100 may be used to protect a vehicle 102 from damage such as defacement, graffiti, burglary, stealing, and so forth. In one embodiment, the vehicle 102 may be protected such that the vehicle 102 remains in a state better than a state the vehicle 102 would have if the vehicle 102 is left out and exposed to the elements.

The vehicle port 100 may also include a lifting device 110. The lifting device 110 may be constructed to assist in lifting the cap 106 from the base. The lifting device 110 may be attached to the cap 106 and the base 104. The lifting device 110 may be located at either end of the vehicle port 100. In one embodiment, the lifting device 110 includes a hydraulic lifting device. In one embodiment, the lifting device 110 provides enough upward force to the cap 106 such that the lifting device 110 will raise the cap 106 unless the cap 106 is forced by another force to close, or held in a closed position by, such as the securing device 108. In one embodiment, the lifting device 110 is a machine. In one embodiment, the lifting device 110 includes a remote control such that the cap 106 may be lifted from the base 104 when one commands the lifting device 110 to open the vehicle port 100.

The cap 106 and base 104 may be constructed of a substantially inflexible material. The substantially inflexible material may be any known in the art. The substantially inflexible material may include any material that would resist allowing items that typically may come into contact with a vehicle 102 when the vehicle 102 is parked. Such items may include hail, sleet, rain, rocks, seeds, toys, baseballs, persons, and so forth. In one embodiment, the inflexible material is a light material such that the cap may be lifted by a single person. Some non-limiting examples of the inflexible material include fiberglass, plastic, metal, wood, glass, polymers, composite materials, and so forth. In one embodiment, the substantially inflexible material includes fiberglass. In another embodiment, the substantially inflexible material includes a substantially transparent material.

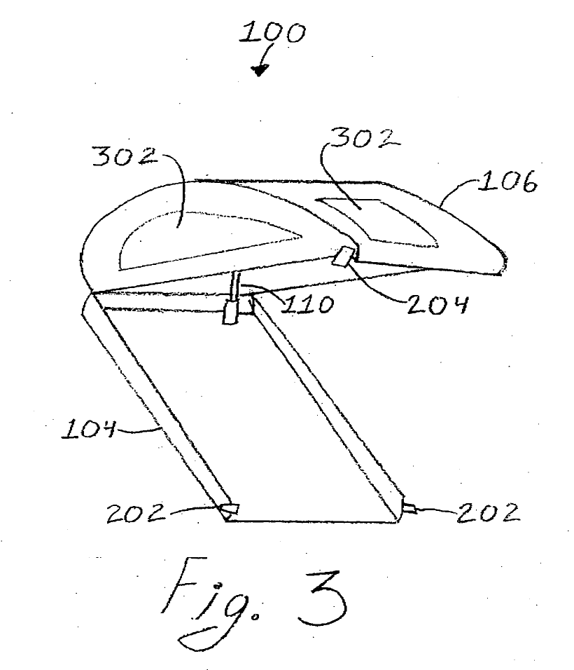

FIG. 2 illustrates a vehicle port 100 in an open position according to one embodiment of the present invention. The vehicle port 100 of this invention includes a securing device 108 (See FIG. 1) that includes two portions. The cap portion 204 of the securing device and the base portion 202 of the securing device communicate to secure the cap 106 and the base 104 in the closed position.

FIG. 3 illustrates a vehicle port 100 in an open position according to one embodiment of the present invention. This embodiment includes a window 302. The window 302 may be constructed of any substantially transparent material known in the art. The window 302 may be included such that the contents of the vehicle port 100 may be viewed though the vehicle port 100 may be in the closed position. The window 302 may be located on any part of the cap 106 or the base 104.

In another embodiment, the present invention also includes a safety release. The safety release may be located on the inside of the vehicle port such that if a person were to be trapped inside of the vehicle port, they could open the vehicle port and exit it. The safety release may be configured similar to a doorknob or door lock such that it may be locked or unlocked from the inside or the outside. The safety release may be configured similar to the safety releases that some auto manufactures place inside the trunks of vehicles that allow a person to exit the trunk if should the person become trapped inside the trunk. In another embodiment, the vehicle port includes a window with a safety release. The safety release may be in opening the window or unlatching the window such that the person could escape the vehicle port.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A vehicle port, comprising:
a base of substantially inflexible material;
a cap of substantially inflexible material, hingedly attached at one end to the base;
a lift-assistance device attached at one end of the vehicle port to both the cap and the base; and
a securing device attached to both the cap and the base,
wherein the cap and the base each comprise perimeter edges which couple.

2. The vehicle port of claim 1, wherein the lift-assistance device comprises a hydraulically powered device to substantially lift the cap from the base providing an opening through which a vehicle may be moved.

3. The vehicle port of claim 1, further comprising a window.

4. The vehicle port of claim 1, wherein the cap and the base comprise fiberglass.

5. The vehicle port of claim 1, wherein the coupling of the perimeter edges of the cap and the base comprises substantially impervious to water.

6. The vehicle port of claim 1, wherein the coupling of the perimeter edges of the cap and base allow the passage of moisture

7. A vehicle port, consisting of:
a base of substantially inflexible material;
a cap of substantially inflexible material, hingedly attached at one end to the base;
a window;
a lift-assistance device attached at one end of the vehicle port to both the cap and the base; and
a securing device attached to both the cap and the base,
wherein the cap and the base each comprise perimeter edges which couple.

8. The vehicle port of claim 6, wherein the lift-assistance device comprises a hydraulically powered device pressurized to substantially lift the cap from the base providing an opening through which a vehicle may be moved.

9. The vehicle port of claim 6, wherein the cap and the base comprise fiberglass.

10. The vehicle port of claim 6, wherein the coupling of the perimeter edges of the cap and the base comprises substantially impervious to water.
